(19) United States
(12) Patent Application Publication
(10) Pub. No.: US 2025/0069184 A1
(43) Pub. Date: Feb. 27, 2025

(54) UPSAMPLING FOR POINT CLOUD FEATURES

(71) Applicant: QUALCOMM Incorporated, San Diego, CA (US)

(72) Inventors: Varun Ravi Kumar, San Diego, CA (US); Risheek Garrepalli, San Diego, CA (US); Senthil Kumar Yogamani, Headford (IE)

(21) Appl. No.: 18/454,940

(22) Filed: Aug. 24, 2023

(51) Int. Cl. G06T 3/40; G01S 17/89; G06T 15/50

(52) U.S. Cl. CPC G06T 3/40; G01S 17/89; G06T 15/503

(57) ABSTRACT

A method of processing image content includes constructing a first graph representation having a first level of point sparsity from a first point cloud data, and performing diffusion-based upsampling on the first graph representation to generate a second graph representation having a second level of point sparsity. Performing diffusion-based upsampling includes inputting the first graph representation into a diffusion-based trained model to generate a first intermediate graph representation having a first intermediate level of point sparsity, inputting the first intermediate graph representation into the diffusion-based trained model to generate a second intermediate graph representation having a second intermediate level of point sparsity, and generating the second graph representation based on at least on the second intermediate graph representation. The method includes generating second point cloud data having the second level of point sparsity based on the second graph representation having the second level of point sparsity.

### TECHNICAL FIELD

This disclosure relates to upsampling point cloud features.

### BACKGROUND

An autonomous driving vehicle is a vehicle that is configured to sense the environment around the vehicle, such as the existence and location of other objects, and operating without human control. An autonomous driving vehicle may include a LiDAR (Light Detection and Ranging) system or other sensor system for sensing point cloud data indicative of the existence and location of other objects around the autonomous driving vehicle. In some examples, such an autonomous driving vehicle may be referred to as an ego vehicle. A vehicle having an advanced driver-assistance system (ADAS) is a vehicle that includes systems which may assist a driver in operating the vehicle, such as parking or driving the vehicle.

### SUMMARY

A system (e.g., ADAS, robotics, drones, etc.) may be configured to identify objects in image data. The ability of the system of identify objects may be based on an effective range of the system and the distance at which the objects are located. The system may be able to accurately identify objects within the effective range of the system. The effective range of the system may be a function of the number of channels (e.g., beams) of the LiDAR system. For instance, the effective range of a LiDAR system with 128 channels is greater than the effective range of a LiDAR system with 64 or 32 channels. However, a LiDAR system with 128 channels tends to be more expensive than a LiDAR system with 64 or 32 channels.

This disclosure describes example techniques of using diffusion upsampling of point cloud features received from a LiDAR system having a first set of channels to generate point cloud features as if from a LiDAR system having a second, greater set of channels. That is, this disclosure describes examples of using diffusion upsampling to interpolate or upsample low resolution point cloud data to a higher resolution point cloud data. Diffusion upsampling is based on diffusion-based models, which are a type of deep learning models that adopt iterative denoising process. For instance, a diffusion-based model solves the prediction task iteratively.

With the example techniques described in this disclosure, using diffusion-based models, it may be possible for a system to generate relatively higher resolution point cloud data from lower resolution point cloud data. In this way, the effective range of the LiDAR system having a lower number of channels is increased without additional expense of utilizing LiDAR systems with higher number of channels.

In one example, the disclosure describes a method of processing image content, the method comprising: receiving first point cloud data having a first level of point sparsity; constructing a first graph representation having the first level of point sparsity from the first point cloud data; performing diffusion-based upsampling on the first graph representation having the first level of point sparsity to generate a second graph representation having a second level of point sparsity, wherein performing diffusion-based upsampling comprises: inputting the first graph representation into a diffusion-based trained model to generate a first intermediate graph representation having a first intermediate level of point sparsity, the first intermediate level of point sparsity being denser than the first level of point sparsity; inputting the first intermediate graph representation into the diffusion-based trained model to generate a second intermediate graph representation having a second intermediate level of point sparsity, the second intermediate level of point sparsity being denser than the first intermediate level of point sparsity; and generating the second graph representation having the second level of point sparsity based on at least on the second intermediate graph representation; and generating second point cloud data having the second level of point sparsity based on the second graph representation having the second level of point sparsity.

In one example, the disclosure describes an apparatus for processing image content, the apparatus comprising: one or more memories; and one or more processors coupled to the one or more memories and implemented in circuitry, wherein the one or more processors are configured to: receive first point cloud data having a first level of point sparsity; construct a first graph representation having the first level of point sparsity from the first point cloud data; perform diffusion-based upsampling on the first graph representation having the first level of point sparsity to generate a second graph representation having a second level of point sparsity, wherein to perform diffusion-based upsampling, the one or more processors are configured to: input the first graph representation into a diffusion-based trained model to generate a first intermediate graph representation having a first intermediate level of point sparsity, the first intermediate level of point sparsity being denser than the first level of point sparsity; input the first intermediate graph representation into the diffusion-based trained model to generate a second intermediate graph representation having a second intermediate level of point sparsity, the second intermediate level of point sparsity being denser than the first intermediate level of point sparsity; and generate the second graph representation having the second level of point sparsity based on at least on the second intermediate graph representation; and generate second point cloud data having the second level of point sparsity based on the second graph representation having the second level of point sparsity.

In one example, the disclosure describes a computer-readable storage medium storing instructions thereon that when executed cause one or more processors to: receive first point cloud data having a first level of point sparsity; construct a first graph representation having the first level of point sparsity from the first point cloud data; perform diffusion-based upsampling on the first graph representation having the first level of point sparsity to generate a second graph representation having a second level of point sparsity, wherein the instructions that cause the one or more processors to perform diffusion-based upsampling comprise instructions that cause the one or more processors to: input the first graph representation into a diffusion-based trained model to generate a first intermediate graph representation having a first intermediate level of point sparsity, the first intermediate level of point sparsity being denser than the first level of point sparsity; input the first intermediate graph representation into the diffusion-based trained model to generate a second intermediate graph representation having a second intermediate level of point sparsity, the second intermediate level of point sparsity being denser than the first intermediate level of point sparsity; and generate the second graph representation having the second level of point sparsity based on at least on the second intermediate graph representation; and generate second point cloud data having the second level of point sparsity based on the second graph representation having the second level of point sparsity.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a block diagram illustrating an example processing system according to one to more aspects of this disclosure.

FIG. 2 is a flowchart illustrating an example process upsampling points in a point cloud.

FIG. 3 is a flowchart illustrating an example process of generating point cloud data having a lower level of point sparsity relative to input point data having a higher level of point sparsity.

FIG. 4 is a flowchart illustrating an example process of training a diffusion-based model.

FIG. 5 is a flowchart illustrating an example method of processing image data in accordance with one or more examples described in this disclosure.

FIG. 6 is flowchart illustrating an example method of upsampling using a diffusion-based model in accordance with one or more examples described in this disclosure.

### DETAILED DESCRIPTION

Various example systems utilize image content captured from one or more sensors for object detection, and may use example techniques described in this disclosure. As some examples, robotic systems, drones, advanced driver assistance system (ADAS), etc. may utilize the example techniques described in this disclosure. For ease, the examples are described with respect to ADAS.

An ADAS uses image content captured from one or more sensors for assisting a driver in various driving scenarios. For instance, the ADAS may determine whether there is an object in the way of vehicle to assist with self-driving, brake warning, etc. One way for the ADAS to determine an object (e.g., whether there is an object, where the object is located, or type of object such as human or not) is based image content captured by a LiDAR system. A LiDAR system outputs a plurality of beams, and determines objects based on the image content captured by outputting of the plurality of beams.

The content from the LiDAR system is in form of a point cloud (e.g., points in a three-dimensional space). The sparsity of the points (e.g., the resolution of the point cloud) may be based on the number of beams used by the LiDAR system. In this disclosure, the term “point sparsity” or “level of point sparsity” refers to a measure of how sparse the points are in the point cloud. The converse of “point sparsity” or “level of point sparsity” is “point density” or “level of point density,” which refers to a measure of how close the points are in the point cloud. The level of point sparsity or the level of point density may be inverse of one another, but generally measure how many points there are within the overall point cloud. For instance, an increase in point sparsity means that there are fewer points in the point cloud, and a decrease in point density. A decrease in point sparsity means that there are more points in the point cloud, and an increase in point density.

The more beams that are used by the LiDAR system results in a denser (e.g., less sparse) point clouds. The fewer beams that are used by the LiDAR system results in a sparser (e.g., less dense) point clouds. In general, the LiDAR systems that provide more beams (e.g., provide denser point clouds) may be well suited for ADAS. For instance, the density of the point cloud may be related to the range (e.g., distance) at which the ADAS can accurately determine an object (e.g., classify object as human). The higher the range of object determination (e.g., detection), the earlier the ADAS can control movement of the vehicle, allowing for smoother deceleration, turning, or early brake warning. Accordingly, there may be benefit in using LiDAR systems with higher number of beams (e.g., to generate denser point clouds), since LiDAR systems with higher number of beams results in increased range of object determination.

However, the cost associated with the LiDAR systems tends to increase with increased number of beams. For instance, the cost of a LiDAR system with 128-channels (e.g., beams) is greater than the cost of a LiDAR system with 64-channels or 32-channels.

This disclosure describes example techniques to utilize first point cloud data having a first level of point sparsity (e.g., higher level of point sparsity or lower level of point density) and generate second point cloud data having a second level of point sparsity (e.g., lower level of point sparsity or higher level of point density). The example techniques utilize a diffusion-based trained model to generate the second point cloud data.

A diffusion-based trained model is a particular type of trained model in which there are a plurality of forward-passes through the diffusion-based trained model, where each pass through the diffusion-based trained model results in a threshold amount of decrease in point sparsity (e.g., threshold amount of increase in point density). A processing circuitry, executing the diffusion-based trained model, may then blend (e.g., integrate) one or more (e.g., including all) results of the forward-pass through the diffusion-based model to generate the second point cloud data. In this example, the second point cloud data is a prediction of point cloud data generated from a LiDAR system that includes a higher number of beams.

For instance, assume that the first point cloud data having the first level of point sparsity is a first point cloud data from a LiDAR system that includes one of 32 or 64 beams. The second point cloud data having the second level of point sparsity may be a second point cloud data indicative of a prediction of point cloud data generated from a LiDAR system that includes 128 beams (e.g., that would have been generated from a LiDAR system that includes 128 beams).

In this way, the example techniques utilize point cloud data having a higher level of point sparsity (e.g., lower point density) to generate point cloud data having a lower level of point sparsity (e.g., higher point density) while keeping costs associated with LiDAR systems low. Furthermore, using diffusion-based trained models, as compared to other machine learning (ML) models, may be beneficial. The iterative process of diffusion-based trained models, where plurality of forward-passes are used, compared to non-iterative trained models, results in a more accurate prediction of point cloud data having lower level of point sparsity (e.g., higher point density). Accordingly, the example techniques described in this disclosure provide for a practical application of generating point cloud data having lowered point sparsity (e.g., increase point density) which improve the operation of various systems such as drones, robots, ADAS, etc. For instance, an ADAS can accurately determine an object at a higher range while using a LiDAR system having lower cost.

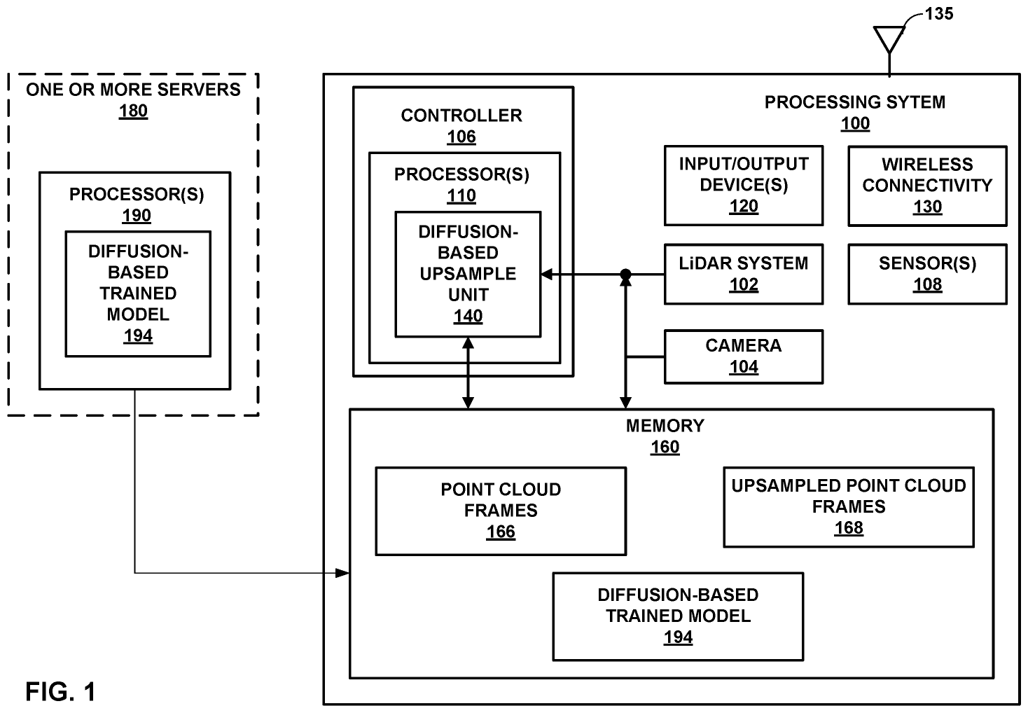

FIG. 1 is a block diagram illustrating an example processing system according to one to more aspects of this disclosure. Processing system 100 may be part of a robotics system, drone system, or other systems that use image content for predicting motion. For ease of description, the examples are described with processing system 100 being used in a vehicle, such as an autonomous driving vehicle or an assisted driving vehicle (e.g., a vehicle having an ADAS or an “ego vehicle”). In such an example, processing system 100 may represent an ADAS. As mentioned, in other examples, processing system 100 may be used in other robotic applications that may include one or more sensors. Although described with respect to ADAS, the example techniques may be applicable for other systems as well.

In the example of FIG. 1, the one or more sensors of processing system 100 include LiDAR system 102, camera 104, and sensors 108. For ease of illustration and description, the example techniques are described with respect to LiDAR system 102 and camera 104. However, the example techniques may be applicable to examples where there is one sensor. The example techniques may also be applicable to examples where different sensors are used in addition to or instead of LiDAR system 102 and camera 104.

Processing system 100 may also include controller 106, input/output device(s) 120, wireless connectivity component 130, and memory 160. LiDAR system 102 may include one or more light emitters (e.g., lasers) and one or more light sensors. LiDAR system 102 may be deployed in or about a vehicle. For example, LiDAR system 102 may be mounted on a roof of a vehicle, in bumpers of a vehicle, and/or in other locations of a vehicle. LiDAR system 102 may be configured to emit light pulses and sense the light pulses reflected off of objects in the environment. LiDAR system 102 may emit such pulses in a 360 degree field around so as to detect objects within the 360 degree field, such as objects in front of, behind, or beside a vehicle. While described herein as including LiDAR system 102, it should be understood that another distance or depth sensing system may be used in place of LiDAR system 102. The output of LiDAR system 102 are called point clouds or point cloud frames.

LiDAR system 102 may be characterized based on a number of beams (e.g., number of sources of the light pulses) that are supported. The number of beams of LiDAR system 102 may also be referred to the number of channels of LiDAR system 102.

A point cloud frame output by LiDAR system 102 is a collection of 3D data points that represent the surface of objects in the environment. These points are generated by measuring the time it takes for a laser pulse to travel from the sensor to an object and back. Each point in the cloud has at least three attributes: x, y, and z coordinates, which represent its position in a Cartesian coordinate system. Some LiDAR systems also provide additional information for each point, such as intensity, color, and classification.

Intensity (also called reflectance) is a measure of the strength of the returned laser pulse signal for each point. The value of the intensity attribute depends on various factors, such as the reflectivity of the object's surface, distance from the sensor, and the angle of incidence. Intensity values can be used for several purposes, including distinguishing different materials, and enhancing visualization. Intensity values can be used to generate a grayscale image of the point cloud, helping to highlight the structure and features in the image content of a scene.

Color information in a point cloud is usually obtained from other sources, such as digital cameras (e.g., camera 104) mounted on the same platform as the LiDAR sensor, and then combined with the LiDAR data, as described in more detail. The color attribute consists of color values (e.g., red, green, and blue (RGB)) values for each point. The color values may be used to improve visualization and aid in enhanced classification (e.g., the color information can aid in the classification of objects and features in the scene, such as vegetation, buildings, and roads.)

Classification is the process of assigning each point in the point cloud to a category or class based on its characteristics or its relation to other points. The classification attribute may be an integer value that represents the class of each point, such as ground, vegetation, building, water, etc. Classification can be performed using various algorithms, often relying on machine learning techniques or rule-based approaches.

In some examples, controller 106 may be configured to perform classification (e.g., object determination). Some techniques for object determination (e.g., object detection and/or classification) utilize approximately four horizontal lines of data. Whether all four horizontal lines of data are available may be based on a range of LiDAR system 102. For instance, “effective range” of LiDAR system 102 may describe the range at which an object can be accurately detected.

With 64-channels (e.g., 64 beams) and a 90° vertical field of view (FoV), the sensor (e.g., LiDAR sensor of LiDAR system 102) has an effective range of 20 meters (m). With the higher resolution of an OSO-128 LiDAR sensor, the effective range is 50% longer, out to 30 m.

The difference in effective range (e.g., distance up to which LiDAR system 102 alone or in combination with controller 106 can detect an object) can impact vehicle or other device operation. For example, an autonomous vehicle is traveling 40 kilometers per hour. The vehicle is moving about 10 meters per second and at that speed has a stopping distance of approximately 15 meters. This means that using a 64-channel sensor, the autonomous shuttle will have 0.5 seconds to identify a pedestrian and begin braking (20 meters of effective range=5 meters to identify, 15 meters to brake). With a 128-channel sensor, the vehicle will have three times as long to react: 30 meters of effective range=15 meters (1.5 seconds) to identify, and 15 meters to brake.

However, 128 beam LiDAR sensors are expensive compared to 64 or 32 beam LiDAR sensors. Therefore, while higher beam (e.g., channel) LiDAR sensors may provide additional range, and therefore better vehicle or device operation, the costs associates with higher beam LiDAR sensors may be prohibitive.

In general, the number of channels (e.g., beams) that a LiDAR sensor supports is indicative of the sparsity of the points in the point cloud data generated by the LiDAR sensor. For instance, LiDAR system 102 may be configured to generate a point cloud that includes a plurality of points. The number of points in the point cloud may be a function of the number of beams of the LiDAR sensor, where the higher number of beams, the higher the number of points. That is, within a same sized point cloud (e.g., 90° vertical FoV), a first LiDAR sensor with more beams than a second LiDAR sensor generates a point cloud with more points than the second LiDAR sensor.

Therefore, in this example, the point sparsity of the points in the point cloud generated from first LiDAR sensor is less than the point sparsity of the points in the point cloud generated from the second LiDAR sensor. That is, the point density of the points in the point cloud generated from first LiDAR sensor is greater than the point sparsity of the points in the point cloud generated from the second LiDAR sensor. Accordingly, the point cloud sparsity or density is a measure of how many points there are in a volume of point cloud, and the lower the point cloud sparsity (e.g., higher the point cloud density), the longer the effective range of the LiDAR sensor is.

As described in more detail, this disclosure describes examples of utilizing a diffusion-based trained model that receives as input first point cloud data generated from a LiDAR sensor having a first level of point sparsity and generates second point cloud data having a second level of point sparsity (e.g., the second level being less than the first level). That is, the second point cloud data is denser than the first point cloud data. In this way, processing system 100 may still be able to use lower cost LiDAR sensor in LiDAR system 102, but achieve a higher effective range available from higher cost LiDAR sensors.

Camera 104 may be any type of camera configured to capture video or image data in the scene (e.g., environment) around processing system 100 (e.g., around a vehicle). For example, camera 104 may include a front facing camera (e.g., a front bumper camera, a front windshield camera, and/or a dashcam), a back facing camera (e.g., a backup camera), side facing cameras (e.g., cameras mounted in sideview mirrors). Camera 104 may be a color camera or a grayscale camera. In some examples, camera 104 may be a camera system including more than one camera sensor. While techniques of this disclosure will be described with reference to a 2D photographic camera, the techniques of this disclosure may be applied to the outputs of other sensors that capture information at a higher frame rate than a LiDAR sensor, including examples of the one or more sensors 108, such as a sonar sensor, a radar sensor, an infrared camera, and/or a time-of-flight (ToF) camera.

Wireless connectivity component 130 may include subcomponents, for example, for third generation (3G) connectivity, fourth generation (4G) connectivity (e.g., 4G LTE), fifth generation connectivity (e.g., 5G or NR), Wi-Fi connectivity, Bluetooth connectivity, and other wireless data transmission standards. Wireless connectivity component 130 is further connected to one or more antennas 135.

Processing system 100 may also include one or more input and/or output devices 120, such as screens, touch-sensitive surfaces (including touch-sensitive displays), physical buttons, speakers, microphones, and the like. Input/output device(s) 120 (e.g., which may include an I/O controller) may manage input and output signals for processing system 100. In some cases, input/output device(s) 120 may represent a physical connection or port to an external peripheral. In some cases, input/output device(s) 120 may utilize an operating system. In other cases, input/output device(s) 120 may represent or interact with a modem, a keyboard, a mouse, a touchscreen, or a similar device. In some cases, input/output device(s) 120 may be implemented as part of a processor (e.g., a processor of processor(s) 110). In some cases, a user may interact with a device via input/output device(s) 120 or via hardware components controlled by input/output device(s) 120.

Controller 106 may be an autonomous or assisted driving controller (e.g., an ADAS) configured to control operation of processing system 100 (e.g., including the operation of a vehicle). For example, controller 106 may control acceleration, braking, and/or navigation of the vehicle through the scene (e.g., environment surrounding the vehicle). Controller 106 may include one or more processors, e.g., processor(s) 110. Processor(s) 110 may include one or more central processing units (CPUs), such as single-core or multi-core CPUs, graphics processing units (GPUs), digital signal processor (DSPs), neural processing unit (NPUs), multimedia processing units, and/or the like. Instructions executed by processor(s) 110 may be loaded, for example, from memory 160 and may cause processor(s) 110 to perform the operations attributed to processor(s) 110 in this disclosure. In some examples, one or more of processor(s) 110 may be based on an ARM or RISC-V instruction set.

An NPU is generally a specialized circuit configured for implementing all the necessary control and arithmetic logic for executing machine learning algorithms, such as algorithms for processing artificial neural networks (ANNs), deep neural networks (DNNs), graph neural networks (GNNs), random forests (RFs), kernel methods, and the like. An NPU may sometimes alternatively be referred to as a neural signal processor (NSP), a tensor processing unit (TPU), a neural network processor (NNP), an intelligence processing unit (IPU), or a vision processing unit (VPU).

Processor(s) 110 may also include one or more sensor processing units associated with LiDAR system 102, camera 104, and/or sensor(s) 108. For example, processor(s) 110 may include one or more image signal processors associated with camera 104 and/or sensor(s) 108, and/or a navigation processor associated with sensor(s) 108, which may include satellite-based positioning system components (e.g., GPS or GLONASS) as well as inertial positioning system components. In some aspects, sensor(s) 108 may include direct depth sensing sensors, which may function to determine a depth of or distance to objects within the environment surrounding processing system 100 (e.g., surrounding a vehicle).

Processing system 100 also includes memory 160, which is representative of one or more static and/or dynamic memories, such as a dynamic random access memory, a flash-based static memory, and the like. In this example, memory 160 includes computer-executable components, which may be executed by one or more of the aforementioned components of processing system 100.

Examples of memory 160 include random access memory (RAM), read-only memory (ROM), or a hard disk. Examples of memory 160 include solid state memory and a hard disk drive. In some examples, memory 160 is used to store computer-readable, computer-executable software including instructions that, when executed, cause a processor to perform various functions described herein. In some cases, memory 160 contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within memory 160 store information in the form of a logical state.

As illustrated, processor(s) 110 may include diffusion-based upsample unit 140. In one or more examples, diffusion-based upsample unit 140 may be configured to upsample first point cloud data received from LiDAR system 102 (e.g., point cloud frames 166 described below) to generate second point data (e.g., upsampled point cloud frames 168 described below).

In the example of FIG. 1, memory 160 stores point cloud frames 166 and upsampled point cloud frames 168. Point cloud frames 166 refer to the raw sensor data from LiDAR system 102, and upsampled point cloud frames 168 refer to the point cloud data generated by diffusion-based upsample unit 140 from upsampling point cloud frames 166.

One or more processors 110 may access point cloud frame 166 and camera images from memory 160 and process point cloud frame 166 and camera images to generate point cloud feature data and camera image feature data. As one example, one or more processors 110 may perform voxelization on point cloud frame 166, such as convert point cloud data of point cloud frames 166 into a plurality of discrete voxels. One or more processors 110 may also construct a graph representation of point cloud frames 166. For instance, one or more processors 110 may determine a respective spatial neighborhood for each voxel of the plurality of discrete voxels, determine adjacency of voxels in each respective spatial neighborhood, and determining an adjacency matrix based on the adjacency of voxels and edge weight of each of the voxels. The graph representation of point cloud frame 166 may be the adjacency matrix.

In one or more examples, diffusion-based upsample unit may be configured to perform diffusion-based upsampling on the graph representation. For instance, the graph representation includes adjacency information of voxels, as well as voxel properties such as intensity or color. Having adjacency information and voxel properties as inputs for diffusion-based upsampling may result in a more accurate prediction of point cloud data having lower point sparsity than the sparsity of point cloud frames 166.

That is, upsample point cloud frames 168 may be a prediction of point cloud data that a LiDAR sensor, having more beams than the LiDAR sensor of LiDAR system 102, would generate. Therefore, the point sparsity of upsampled point cloud frames 168 may be lower than the point sparsity of point cloud frames 166. By using the graph representation for diffusion-based upsampling, diffusion-based upsample unit 140 may add in additional voxels having a location and properties that more closely resemble point cloud data that would have been generated by a LiDAR system with more channels, as compared to if the graph representation were not used.

Accordingly, one or more processors 110 may receive first point cloud data having a first level of point sparsity (e.g., point cloud frames 166), and construct a first graph representation having the first level of point sparsity from the first point cloud data, as described above. Diffusion-based upsample unit 140 may perform diffusion-based upsampling on the first graph representation having the first level of point sparsity to generate a second graph representation having a second level of point sparsity (e.g., upsampled point cloud frames 168). In this example, the first level of point sparsity is greater than the second level of point sparsity. In other words, upsampled point cloud frames 168 are denser than point cloud frames 166.

To perform diffusion-based upsampling, diffusion-based upsample unit 140 may be configured to execute diffusion-based trained model 194. As illustrated, one or more servers 180 that include one or more processors 190 may be configured to generate diffusion-based trained model 194 that is then stored in memory 160. Diffusion-based upsample unit 140 may access diffusion-based trained model 194 for execution. Example ways in which one or more processors 190 of one or more servers 180 generate diffusion-based trained model 194 is described in more detail below.

In general, diffusion-based models are a type of deep learning model that adopt iterative denoising process. For instance, diffusion-based trained model 194, when executed, is configured to solve the prediction task iteratively. In one or more examples, diffusion-based upsample unit 140, in response to execution or application of diffusion-based trained model 194 on point cloud frames 166, may iteratively propagate information from neighboring points (e.g., in the graph presentation of point cloud frames 166) to fill in the missing data (e.g., to add voxels to decrease point sparsity or increase point density).

To iteratively solve the prediction task, diffusion-based upsample unit 140 may be configured to execute a plurality of forward-passes through diffusion-based trained model 194, where the result of each pass through diffusion-based trained model 194 becomes the input for the next forward pass through diffusion-based trained model 194. Also, the result of each forward pass through diffusion-based trained model 194 is a graph representation with a threshold decrease in point sparsity (e.g., threshold increase in point density).

For example, diffusion-based upsample unit 140 may input the first graph representation (e.g., generated from point cloud frames 166) into diffusion-based trained model 194 to generate a first intermediate graph representation having a first intermediate level of point sparsity. The first intermediate level of point sparsity is denser than the first level of point sparsity. That is, the first intermediate level of point sparsity of the first intermediate graph representation is less sparse (e.g., denser) than the first level of point sparsity of the first graph representation.

Diffusion-based upsample unit 140 may input the first intermediate graph representation into diffusion-based trained model 194 to generate a second intermediate graph representation having a second intermediate level of point sparsity. The second intermediate level of point sparsity is denser than the first intermediate level of point sparsity. That is, the second intermediate level of point sparsity of the second intermediate graph representation is less sparse (e.g., denser) than the first intermediate level of point sparsity of the first intermediate graph representation.

Diffusion-based upsample unit 140 may generate the second graph representation having the second level of point sparsity (e.g., a graph representation of upsampled point cloud frames 168) based on at least on the second intermediate graph representation. For example, assume that the second intermediate graph representation having the second intermediate level of point sparsity is a current instance of graph representation having a current level of point sparsity. In this example, diffusion-based upsample unit 140 may iteratively update the current instance of the graph representation to generate an updated instance of the graph representation having an updated level of point sparsity based on iteratively inputting the current instance of graph representation into diffusion-based trained model 194 until the updated level of point sparsity is equal to the second level of point sparsity.

In some examples, the intermediate graph representation having the second level of point sparsity may be equal to the graph representation of upsampled point cloud frames 168. However, in some examples, diffusion-based upsample unit 140 may blend together (e.g., by integrating) each result of forward-pass through diffusion-based trained model 194. For instance, to generate the second graph representation, diffusion-based upsample unit 140 may blend together respective instances of the graph representation, the first intermediate graph representation, and the second intermediate graph representation (e.g., the result of each forward-pass through diffusion-based trained model 194) to generate the second graph representation.

As an illustration of the iterative process for upsampling, assume that the LiDAR sensor of LiDAR system 102 includes 64-channels, and the result from the prediction is to generate a point cloud as if a LiDAR sensor having 128-channels generated the point cloud. In this example, diffusion-based upsample unit 140 may generate a first graph representation having the first level of point sparsity (e.g., point sparsity associated with 64-channel LiDAR sensor) based on the point cloud data from the LiDAR sensor.

Diffusion-based upsample unit 140 may input the first graph representation having the first level of point sparsity into diffusion-based trained model 194, and generate a first intermediate graph representation having a first intermediate level of point sparsity. In this example, the first intermediate graph representation may represent a graph representation of a point cloud generated from a 68-channel LiDAR sensor. Accordingly, the first intermediate level of point sparsity is denser than the first level of point sparsity (e.g., the first intermediate graph representation of a 68-channel LiDAR sensor is denser than the first graph representation of a 64-channel LiDAR sensor).

Diffusion-based upsample unit 140 may input the first intermediate graph representation having the first intermediate level of point sparsity into diffusion-based trained model 194, and generate a second intermediate graph representation having a second intermediate level of point sparsity. In this example, the second intermediate graph representation may represent a graph representation of a point cloud generated from a 72-channel LiDAR sensor. Accordingly, the second intermediate level of point sparsity is denser than the first intermediate level of point sparsity (e.g., the second intermediate graph representation of a 72-channel LiDAR sensor is denser than the first intermediate graph representation of a 68-channel LiDAR sensor).

Diffusion-based upsample unit 140 may repeat these operations until diffusion-based upsample unit 140 generates a graph representation having a level of point sparsity that is equal to the point sparsity of a 128-channel LiDAR sensor. In some examples, diffusion-based upsample unit 140 may use the graph representation having the level of point sparsity that is equal to the point sparsity of a 128-channel LiDAR sensor has the graph representation from which diffusion-based upsample unit 140 generates upsampled point cloud frames 168. In some examples, diffusion-based upsample unit 140 may blend each of the graph representations (e.g., the result from each forward-pass through diffusion-based trained model 194) to generate a final graph representation. Diffusion-based upsample unit 140 may generate upsampled point cloud frames 168 from the final graph representation.

The following provides an overview of the operation of diffusion-based upsample unit 140. Let I(x, y) be the intensity of the LiDAR signal at a point (x, y) in the LiDAR sensor scan. The diffusion equation for signal intensity I can be represented as: ∂I/∂t=D∇²I, where ∂I/∂t represents the rate of change of signal intensity over time, D is the diffusion coefficient, which is indicative of how quickly the signal diffuses, and ∇² is the Laplacian operator, which describes the rate of change of the signal intensity at each point. The Laplacian operator may be considered as measuring the difference between the average intensity of the signal in the neighborhood of a point and the intensity at the point itself.

By iteratively solving the diffusion equation for the LiDAR point cloud data, diffusion-based upsample unit 140, executing or implementing diffusion-based trained model 194, propagates information from neighboring points to fill in missing data and obtain a more complete representation of the scene. That is, diffusion-based trained model 194 may cause diffusion-based upsample unit 140 to propagate information from neighboring points based on the weights and scales determined from training to increase the density (e.g., lower the sparsity) of points in the point cloud through each iteration (e.g., through each forward-pass through diffusion-based trained model 194). For instance, diffusion-based trained model 194 is configured to propagate information from neighboring points in the point cloud data of point cloud frames 166 to a point in the point cloud data of point cloud frames 166 to generate additional points. The information may include average intensity of neighboring points and an intensity of the point.

Additionally, diffusion-based trained model may be used in point cloud sampling to generate new points that are consistent with the underlying distribution of the original point cloud (e.g., point cloud frames 166). This process is often referred to as “diffusion sampling” and can be used to generate high-quality synthetic point clouds for downstream tasks such as object detection and segmentation. That is, upsampled point cloud frames 168 may be synthetic (e.g., predicted) point clouds that controller 106 can use for object detection or segmentation, and control vehicle or other device operation accordingly.

As illustrated in FIG. 1, one or more servers 180 include one or more processors 190 that are configured to generate diffusion-based trained model 194. To generate diffusion-based trained model 194, one or more processors 190 may receive point cloud data having relatively high density as the ground truth. For instance, one or more processors 190 may receive point cloud data generated from a 128-channel LiDAR sensor.

From the relatively high density point cloud data, one or more processors 190 may determine a plurality of sets of training point cloud data. Each set of training point cloud data may be one threshold amount sparser than another set of training point cloud data. For example, one or more processors 190 may remove 3.125% of points from high density point cloud data to generate first set of training point cloud data, which is point cloud data as if a 124-channel LiDAR sensor generated the point cloud data (e.g., 0.03125*128=124). One or more processors 190 may remove 6.25% of points from high density point cloud data to generate second set of training point cloud data, which is point cloud data as if a 120-channel LiDAR sensor generated the point cloud data, and so forth until one or more processors 190 remove 50% of points from the high density point cloud data to generate an Nth set of training point cloud data, which the point cloud data as if a 64-channel LiDAR sensor generated the point cloud data (in this example, assume that LiDAR system 102 includes a 64-channel LiDAR sensor).

One or more processors 190 may train a diffusion-based model using the plurality of sets of training point cloud data. As part of the training, one or more processors 190 may update the weights and scales of nodes of the diffusion-based model so that the result of any set of training point cloud data is approximately the same as one of the training point cloud data that is one threshold denser.

For instance, as part of training, one or more processors 190 may have generated a first set of training point cloud data having point sparsity of a 100-channel LiDAR sensor, a second set of training point cloud data having point sparsity of a 104-channel LiDAR sensor, and a third set of training point cloud data having point sparsity of a 108-channel LiDAR sensor. In this example, sequentially or in parallel, one or more processors 190 may input the first set of training point cloud data into the diffusion-based model, as part of training, and generate a predicted second point cloud data having an point sparsity of a 104-channel LiDAR sensor, and input the second set of training point cloud data into the diffusion-based model, as part of training, and generate a predicted third point cloud data having an point sparsity of a 108-channel LiDAR sensor.

One or more processors 190 may compare, as part of a loss function, the predicted second point cloud data having the point sparsity of a 104-channel LiDAR sensor, and the second set of training point cloud data having point sparsity of the 104-channel LiDAR sensor. Similarly, one or more processors 190 may compare, as part of a loss function, the predicted third point cloud data having the point sparsity of a 108-channel LiDAR sensor, and the third set of training point cloud data having point sparsity of the 108-channel LiDAR sensor. Based on the comparison, one or more processors 190 may update the weights and scales of nodes of the neural network that form the diffusion-based model. The diffusion-based model may be a graph neural network (GNN). One or more processors 190 may perform such operations for each of point clouds at different point sparsity levels, and perform such operations using different input point clouds as ground truths.

The result from the training is diffusion-based trained model 194. One or more processors 110 may receive, from one or more servers 180, diffusion-based trained model 194 that has been trained based on a plurality of sets of training point cloud data. As described, each set of training point cloud data is one threshold amount sparser than another set of training point cloud data. The threshold amount sparser may be 3.125% sparser relative to the original sparsity amount (e.g., 128-channels). However, other examples are possible.

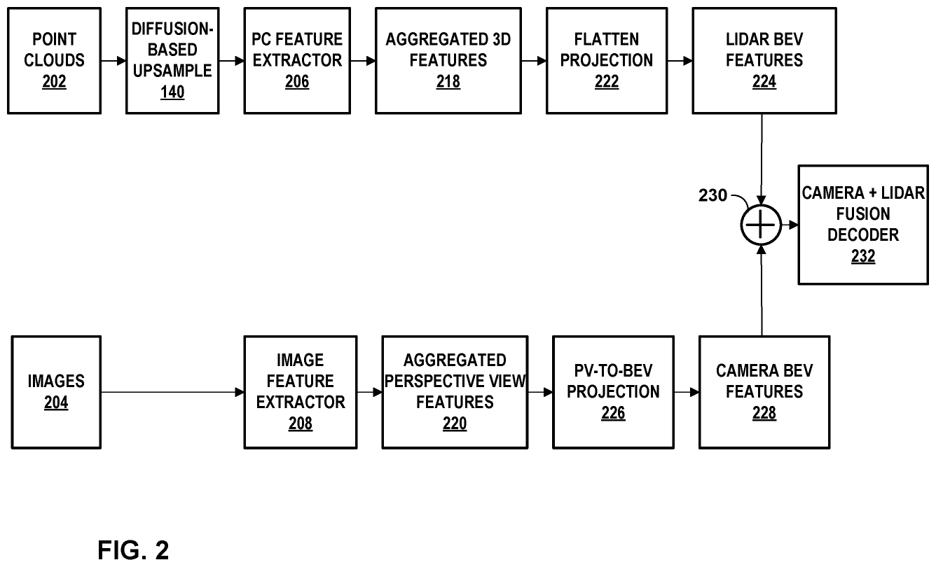

FIG. 2 is a flowchart illustrating an example process predicting movement of objects. In the example of FIG. 2, one or more processors 110 acquire point clouds (202) and acquires images (204). The point clouds and images may constitute raw data acquired by sensors, such as LiDAR system 102 and camera 104, respectively.

As illustrated in FIG. 2, diffusion-based upsample unit 140 may receive point cloud 202 having a first level of point sparsity. In one or more examples, diffusion-based upsample unit 140 of one or more processors 110 may construct a first graph representation having the first level of point sparsity from the first point cloud data, and perform diffusion-based upsampling on the first graph representation having the first level of point sparsity to generate a second graph representation having a second level of point sparsity. To perform diffusion-based upsampling, diffusion-based upsample unit 140 may be configured to input the first graph representation into a diffusion-based trained model to generate a first intermediate graph representation having a first intermediate level of point sparsity, and input the first intermediate graph representation into the diffusion-based trained model to generate a second intermediate graph representation having a second intermediate level of point sparsity. In this example, the first intermediate level of point sparsity is denser than the first level of point sparsity, and the second intermediate level of point sparsity is denser than the first intermediate level of point sparsity.

Diffusion-based upsample unit 140 may generate the second graph representation having the second level of point sparsity based on at least on the second intermediate graph representation. One or more processors 110 or diffusion-based upsample unit 140 may generate second point cloud data having the second level of point sparsity based on the second graph representation having the second level of point sparsity. For example, one or more processors 110 or diffusion-based upsample unit 140 may deconstruct the second graph representation into the second point cloud data having the second level of point sparsity. That is, one or more processors 110 may perform a process of receiving a graph representation as an input, and outputting point cloud data, which is in the inverse process of receiving point cloud data, and outputting a graph representation.

One or more processors 110 perform point-cloud feature extraction (206) on the acquired point clouds and perform image features extraction (208) on the acquired images. One or more processors 110 may, for example, identify shapes, lines, or other features in the point clouds and images that may correspond to real-world objects of interest. Performing feature extraction on the raw data may reduce the amount of data in the frames as some information in the point clouds and images may be removed. For example, data corresponding to unoccupied voxels of a point cloud may be removed.

One or more processors 110 may store a set of aggregated 3D features (218). That is, one or more processors 110 may maintain a buffer with point cloud frames. One or more processors 110 may add new point clouds to the buffer at a fixed frequency and/or in response to processing system 100 having moved a threshold unit of distance.

One or more processors may store a set of aggregated perspective view features (220). That is, one or more processors 110 may maintain a buffer with sets of images. The images in the buffer, due to feature extraction and/or down sampling, may have reduced data relative to the raw data acquired by camera 104. One or more processors 110 may add new images to the buffer at a fixed frequency and/or in response to processing system 100 having moved a threshold unit of distance.

One or more processors 110 may flatten projection (222) on the point cloud frames, e.g., on the aggregated 3D sparse features. Flatten projection converts the 3D point cloud data into 2D data, which creates a birds-eye-view (BEV) perspective of the point cloud (224), e.g., data indicative of LiDAR BEV features in the point clouds. One or more processors 110 may perform perspective view (PV)-to-BEV projection (226) on the images, e.g., the aggregated perspective view features. PV-to-BEV projection converts the image data into 2D BEV data, using for example matrix multiplication, which creates data indicative of camera BEV features (228).

The LiDAR BEV features and the camera BEV features are combined (230) and input into a camera/LiDAR fusion decoder 232. Camera/LiDAR fusion decoder 232 may also be referred to as a cross-modal attention network. The fusion decoder extracts features from a feature space and decodes those features into a scene space corresponding to the originally-acquired point clouds and images.

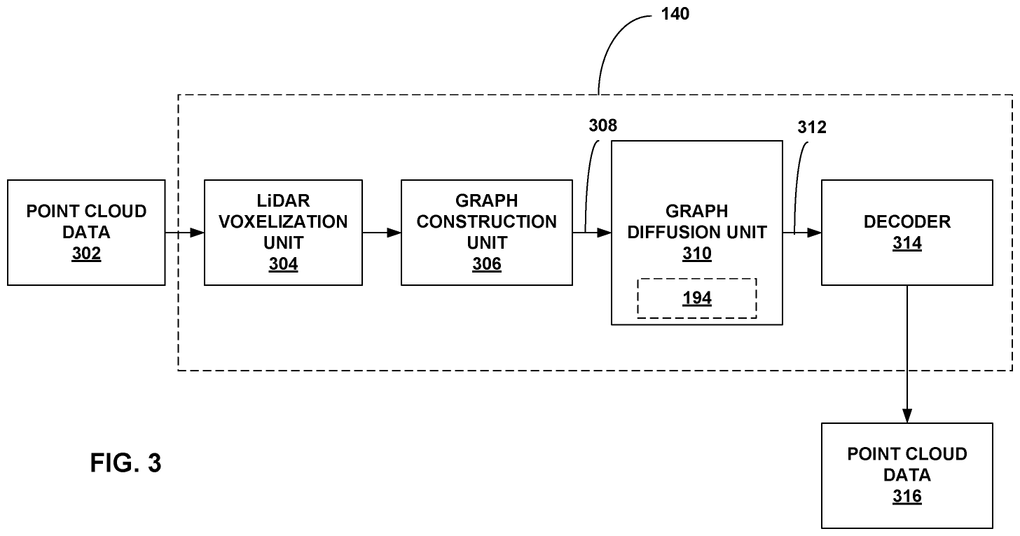

FIG. 3 is a flowchart illustrating an example process of generating point cloud data having a lower level of point sparsity relative to input point data having a higher level of point sparsity. As illustrated in FIG. 3, diffusion-based upsample unit 140 receives point cloud data 302 (e.g., point cloud 202 of FIG. 2 or point cloud frames 166 of FIG. 1).

Diffusion-based upsample unit 140 includes LiDAR voxelization unit 304, graph construction unit 306, graph diffusion unit 310, and decoder 314. In the example of FIG. 3, the output of diffusion-based upsample unit 140 is point cloud data 316. For instance, diffusion-based upsample unit 140 receives first point cloud data 302 having a first level of point sparsity, and generates second point cloud data 316 having the second level of point sparsity. In this example, the second level of point sparsity is denser (e.g., less sparse) than the first level of point sparsity.

LiDAR voxelization unit 304 may be configured to convert first point cloud data 302 into a plurality of discrete voxels. For instance, LiDAR voxelization unit 304 voxelizes input point cloud 302 to convert the continuous point cloud data into a discrete voxel representation.

Graph construction unit 306 may be configured to construct a first graph representation 308 of first point cloud data 302 after voxelization. To construct graph representation 308, graph construction unit 306 may be configured to determine a respective spatial neighborhood for each voxel of the plurality of discrete voxels, determine adjacency of voxels in each respective spatial neighborhood, and determine an adjacency matrix based on the adjacency of voxels and edge weight of each of the voxels. The first graph representation 308 is the adjacency matrix.

For instance, graph construction unit 306 may perform the following operations. Graph construction unit 306 may define the spatial neighborhood for each voxel, which involves specifying a radius or distance threshold that determines which voxels are considered to be neighbors. Once the spatial neighborhood has been defined, graph construction unit 306 constructs the adjacency matrix for the graph. The adjacency matrix is a square matrix that has a size equal to the number of voxels in the voxel grid. Each entry in the matrix may represent an edge between two voxels and is set to one if the corresponding voxels are neighbors and zero otherwise. Adjacency matrix A can be defined as follows:
Aᵢⱼ=1 if the iₜₕ and jₜₕ voxels are neighbors Aᵢⱼ=0 otherwise

Each voxel in the first graph representation 308 represents a node, and the edges between nodes are defined based on their spatial proximity. First graph representation 308 is typically represented as an adjacency matrix. Edge weights are assigned to each edge in the first graph representation 308 based on some measure of similarity or distance between the corresponding voxels. For example, the edge weight can be set to the distance between the voxel centroids, or to a similarity measure based on voxel properties such as intensity or color. Adjacency matrix with edge weights W can be defined as follows:

$${W}_{ij} = {w}_{ij} if the {i}_{th} and {j}_{th} voxels are neighbors {W}_{ij} = 0 otherwise$$

where wᵢⱼ is the weight assigned to the edge between the iₜₕ and jₜₕ voxels.

In general, constructing first graph representation 308 from voxelized point cloud data provides a way to capture the spatial relationships between the points in a more structured and organized format as compared to using point cloud data. Accordingly, diffusion-based upsample unit 140 may be configured to provide a more accurate prediction of point cloud data having a lower point sparsity (e.g., higher point density), as compared to the other techniques.

Graph diffusion unit 310 may receive the first graph representation 308. Graph diffusion unit 310 may be an example unit on which diffusion-based trained model 194 executes. For example, graph diffusion unit 310 may perform diffusion-based upsampling on the first graph representation 308 having the first level of point sparsity to generate a second graph representation 312 having a second level of point sparsity. Graph diffusion unit 310 may input the first graph representation 308 into a diffusion-based trained model 194 to generate a first intermediate graph representation having a first intermediate level of point sparsity. The first intermediate level of point sparsity may be denser than the first level of point sparsity.

Graph diffusion unit 310 may input the first intermediate graph representation into the diffusion-based trained model 194 to generate a second intermediate graph representation having a second intermediate level of point sparsity. The second intermediate level of point sparsity being denser than the first intermediate level of point sparsity.

Graph diffusion unit 310 may generate the second graph representation 312 having the second level of point sparsity based on at least on the second intermediate graph representation. There may be various iterations through diffusion-based trained model 194 in addition to the two iterations. For instance, assume the second intermediate graph representation having the second intermediate level of point sparsity is a current instance of graph representation having a current level of point sparsity. Graph diffusion unit 310 may iteratively update the current instance of the graph representation to generate an updated instance of the graph representation having an updated level of point sparsity based on iteratively inputting the current instance of graph representation into the diffusion-based trained model until the updated level of point sparsity is equal to the second level of point sparsity. In one example, graph diffusion unit 310 may generate the second graph representation 312 by blending together respective instances of the graph representation, the first intermediate graph representation, and the second intermediate graph representation to generate the second graph representation 312. In some examples, the last intermediate graph representation having the second level of point sparsity may be equal to second graph representation 312 having the second level of point sparsity.

In general, graph diffusion unit 310, executing, implementing, or applying diffusion-based trained model 194, performs a process on the first graph representation 308 to extract features from the voxelized point cloud data. This process may involve propagating information from each node to its neighbors in first graph representation 308, weighted by the similarity between the nodes. This process can be modeled using a diffusion operator, such as the Laplacian matrix.

The diffusion operator defines how information is propagated from each node to its neighbors in the graph. The most common diffusion operator used in graph-based feature extraction is the Laplacian matrix. The Laplacian matrix L is defined as: L=D−A, where D is the degree matrix (a diagonal matrix where each element represents the sum of weights of edges connected to a given node), and A is the adjacency matrix (a binary matrix where each element represents the presence or absence of an edge between two nodes). The Laplacian matrix characterizes the connectivity and smoothness of the graph.

As noted above, the diffusion process involves propagating information from each node to its neighbors in the first graph representation 308, weighted by the similarity between the nodes. This can be modeled using a diffusion kernel (e.g., by execution of diffusion-based trained model 194), which describes the probability that a random walk starting at node i will reach node j after t steps. The diffusion kernel K is defined as: K(t)=exp(−tL), where t is a diffusion time parameter that controls the scale of the diffusion process.

Once the diffusion operator and kernel have been defined, graph diffusion unit 310 performs the diffusion process by applying the kernel (e.g., applying diffusion-based trained model 194) to the initial node features. This results in a diffusion map, which contains the diffusion coordinates for each node. The diffusion map X is defined as X=K(t)F, where F is the initial node feature matrix.

Graph diffusion unit 310 may propagate the extracted diffusion map features through the graph using an up-sampling operation, which increases the resolution of the data. That is, graph diffusion unit 310 generates second graph representation 312 having a second level of point sparsity, where the second level of point sparsity is denser than the first level of point sparsity (e.g., point sparsity of first graph representation 308). The up-sampling operation may be performed using a graph convolutional neural network (GCN), which applies a convolution operation in the spectral domain of the graph. However, other up-sampling operations are possible. Given a signal f on the nodes of the graph and a filter h, the convolution operation can be defined as: f*h=UhU^{T}f, where U is the matrix of eigenvectors of the Laplacian matrix L, and h is the filter in the spectral domain.

The up-sampled signal is then obtained by applying the filter h to the input signal f in the spectral domain followed folding by decoder 314 to obtain dense point clouds. For example, decoder 314 may deconstruct the second graph representation 312 into the second point cloud data 316 having the second level of point sparsity. As one example, decoder 314 may be configured to perform the inverse operations of graph construction unit 306 and LiDAR voxelization unit 304 to generate second point cloud data 316 having the second level of point sparsity. For instance, second point cloud data 316 may be denser than first point cloud data 302. As one example, the first point cloud data 302 having the first level of point sparsity may be first point cloud data from a LiDAR system 102 that includes one of 32 or 64 beams (e.g., LiDAR sensor includes one of 32-channels or 64-channels). In this example, the second point cloud data 316 having the second level of point sparsity may be a second point cloud data indicative of a prediction of point cloud data generated from a LiDAR system that includes 128 beams.

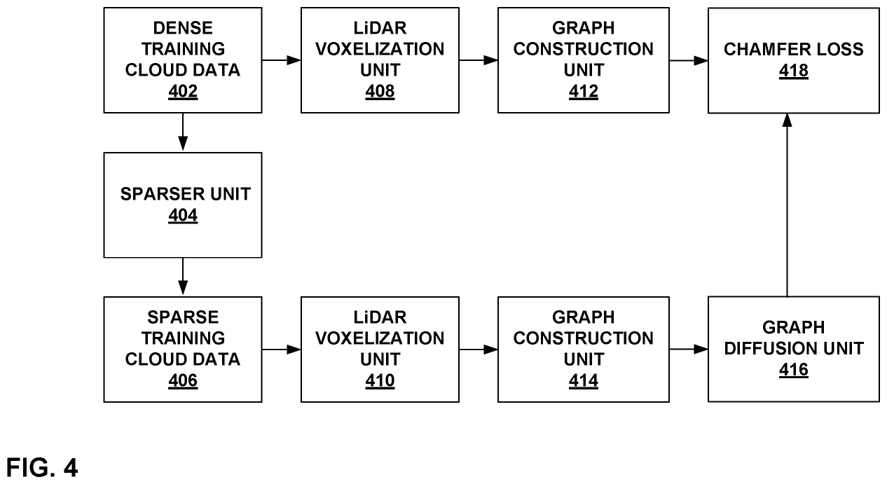

FIG. 4 is a flowchart illustrating an example process of training a diffusion-based model. One or more processors 190 may receive dense training cloud data 402. Sparser unit 404 receives dense training cloud data 402 and generates a plurality of sets of training point cloud data. For instance, each set of training point cloud data that sparser unit 404 generates may be one threshold amount sparser than another set of training point cloud data. As an example, sparser unit 404 may generate point cloud data having point sparsity level of 124-channel LiDAR sensor, 120-channel LiDAR sensor, 116-channel LiDAR sensor, and so forth.

For ease of illustration, FIG. 4 illustrates one of the plurality of sets of training point data. However, there are a plurality of sets of training point data on which one or more processors 190 perform similar operations. Also, for ease of illustration, assume that dense training cloud data 402 is a point cloud having point sparsity of 104-channel LiDAR sensor, and sparse training cloud data 406 is a point cloud having point sparsity of 100-channel LiDAR sensor. Again, only one example of dense training cloud data 402 and sparse training cloud data 406 is illustrated for ease, with the understanding that similar operations are occurring in parallel or sequentially with other sets of training point cloud data.

LiDAR voxelization unit 408 receives dense training cloud data 402 and generates voxelized point cloud that graph construction unit 412 receives. LiDAR voxelization unit 410 receives sparse training cloud data 406 and generates voxelized point cloud that graph construction unit 414 receives. LiDAR voxelization unit 408 and LiDAR voxelization unit 410 are similar, including identical, to LiDAR voxelization unit 304 of FIG. 3.

Graph construction unit 412 may generate a ground truth graph representation from the voxelized point cloud that LiDAR voxelization unit 408 outputs. Graph construction unit 414 may generate a training graph representation from the voxelized point cloud that LiDAR voxelization unit 410 outputs. Graph construction unit 412 and graph construction unit 414 may be similar, including identical, to graph construction unit 306 of FIG. 3.

Graph diffusion unit 416 receives training graph representation, and applies a diffusion-based model, currently being trained, to generate a predicted graph representation. The point sparsity of the predicted graph representation and the ground truth graph representation should be the same, and the predicted graph representation should be similar to the ground truth graph representation.

Chamfer loss 418 may be indicative of a difference between the ground truth graph representation and the predicted graph representation. One or more processors 190 may use the chamfer loss 418 to update the weights and scales of nodes of the neural network (e.g., GNN) that form the diffusion-based model to minimize chamfer loss 418. After the training, the result may be diffusion-based trained model 194.

The example of FIG. 4 may be considered as follows. Sparser unit 404 may be considered as adding noise (e.g., by removing points, the point cloud becomes “noisier”). As described, each of the training point cloud data may be sparser than another, and therefore, the noise can be considered as increasing over time.

One or more processors 190 may corrupt the input training point cloud with noise according to the pre-defined noise schedule. The amount of noise added to the point cloud at each iteration is controlled by the current value of the noise schedule.

One or more processors 190 may train the diffusion-based model, which may be a GNN, to denoise (e.g., replace the missing points removed as part of adding noise). For instance, one or more processors 190 may train a GNN (∈_{θ}) to denoise the corrupted point cloud with respect to the current noise level (Δ_{∈}). The network takes the noisy point cloud (e.g., point cloud with missing points) as input and produces a denoised point cloud as output (e.g., point cloud with added points to increase the density one threshold amount). The training objective may be defined as a reconstruction loss between the denoised point cloud and the original point cloud.

In one or more examples, as described above, the noise schedule is used to sparsify or reduce the density of the input point cloud. The amount of sparsification is controlled by the current value of the noise schedule. In one or more examples, one or more processors 190 are configured to train a neural network ∈_{θ} to densify the sparse point cloud with respect to the current sparsification level Δ_{∈}. The network takes the sparse point cloud as input and produces a dense point cloud as output. The training objective is typically defined as a Chamfer loss between the dense point cloud and the original point cloud.

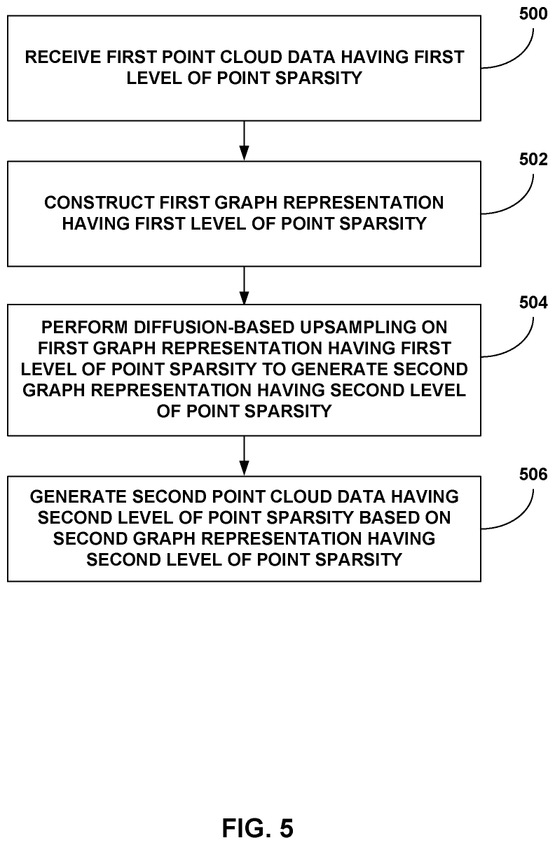

FIG. 5 is a flowchart illustrating an example method of processing image data in accordance with one or more examples described in this disclosure. One or more processors 110 may be configured to receive first point cloud data having a first level of point sparsity (500). Examples of the first point cloud data include point cloud frames 166, point cloud 202, and first point cloud data 302. The first point cloud data having the first level of point sparsity may be the first point cloud data from a LiDAR system 102 that includes one of 32 or 64 beams.

One or more processors 110 may construct first graph representation 308 having the first level of point sparsity from the first point cloud data (502). For example, one or more processors 110 may convert the first point cloud data into a plurality of discrete voxels (e.g., via LiDAR voxelization unit 304). One or more processors 110 (e.g., via graph construction unit 306) may determine a respective spatial neighborhood for each voxel of the plurality of discrete voxels, determine adjacency of voxels in each respective spatial neighborhood, and determine an adjacency matrix based on the adjacency of voxels and edge weight of each of the voxels. The first graph representation 308 may be the adjacency matrix.

One or more processors 110 may perform diffusion-based upsampling on the first graph representation 308 having the first level of point sparsity to generate a second graph representation 312 having a second level of point sparsity (506). For instance, one or more processors 110 may input the first graph representation into a diffusion-based trained model 194 to generate a first intermediate graph representation having a first intermediate level of point sparsity, the first intermediate level of point sparsity being denser than the first level of point sparsity, and input the first intermediate graph representation into the diffusion-based trained model 194 to generate a second intermediate graph representation having a second intermediate level of point sparsity, the second intermediate level of point sparsity being denser than the first intermediate level of point sparsity. One or more processors 110 may generate the second graph representation having the second level of point sparsity based on at least on the second intermediate graph representation.

For example, one or more processors 110 may iteratively update a current instance of the graph representation to generate an updated instance of the graph representation having an updated level of point sparsity based on iteratively inputting the current instance of graph representation into the diffusion-based trained model 194 until the updated level of point sparsity is equal to the second level of point sparsity. In some examples, one or more processors 110 may blend together respective instances of the graph representation, the first intermediate graph representation, and the second intermediate graph representation to generate the second graph representation 312.

For instance, at inference time (e.g., when performing diffusion-based upsampling), diffusion-based upsample unit 140 starts with a sparse point cloud X₀∈ [symbol] ^{(n×3)} with n sparse points, and densifies this point cloud by applying diffusion-based trained model 194 (∈_{θ}) iteratively. Let Yₖ∈ [symbol] ⁽⁽⁴^{^{k}}^{)×3)} denote the densified point cloud at iteration k, where the number of points in Yₖ is 4^{k}. The iterative densification process can be formulated as: Yₖ=∈_{θ}(Yₖ₋₁) for k=1, 2, 3, . . . , K, where K is the number of iterations graph diffusion unit 310 (of FIG. 3) performs to achieve the desired level of point cloud density. Here, Yₖ₋₁ is the output from the previous iteration. At each iteration k, every point in the input point cloud Y_{k_1} is replaced by four new points that lie on a regular grid in 3D space. This grid is obtained by subdividing each edge of the original input point cloud into two equal parts. The number of points in the output point cloud at iteration k is four times the number of points in the input point cloud at iteration k−1, which is given by 4^{(k-1)}.

Diffusion-based trained model 194 (∈_{θ}) takes the input point cloud Yₖ₋₁ and produces a denser point cloud Yₖ. For instance, Yₖ=∈_{θ}(Yₖ₋₁)=f_{θ}(Yₖ₋₁)+σε, where σ is a scaling factor, ε·N(0, I) is a random vector drawn from a normal distribution, and f_{θ} is the neural network that maps Yₖ₋₁ to Yₖ.

The above equation represents a stochastic process, where added in is a random perturbation GE to the output of the neural network f_{θ}. This helps to introduce diversity in the generated point clouds and makes the process more robust to small changes in the input.

The final output point cloud Yₖ obtained after K iterations is the densified point cloud that is used for downstream tasks. The iterative densification process can be seen as a form of probabilistic inference, where the start is a sparse point cloud and iteratively refine it to obtain a denser and more accurate representation of the underlying scene (e.g., for object detection or some other purpose).

One or more processors 110 may generate second point cloud data 302 having the second level of point sparsity based on the second graph representation 312 having the second level of point sparsity (506). For example, decoder 314 may deconstruct the second graph representation 312 into the second point cloud data 316 having the second level of point sparsity. The second point cloud data 316 having the second level of point sparsity may be a second point cloud data indicative of a prediction of point cloud data generated from a LiDAR system that includes 128 beams.

In one or more examples, controller 106 may control operation of a vehicle based on the generated second point cloud data. For example, controller 106 may detect an object using the second point cloud data, and control movement (e.g., brake, turn, etc.) or control alerts (e.g., audio, haptic, and/or visual warning) to the user based on the detection of the object using the second point cloud data.

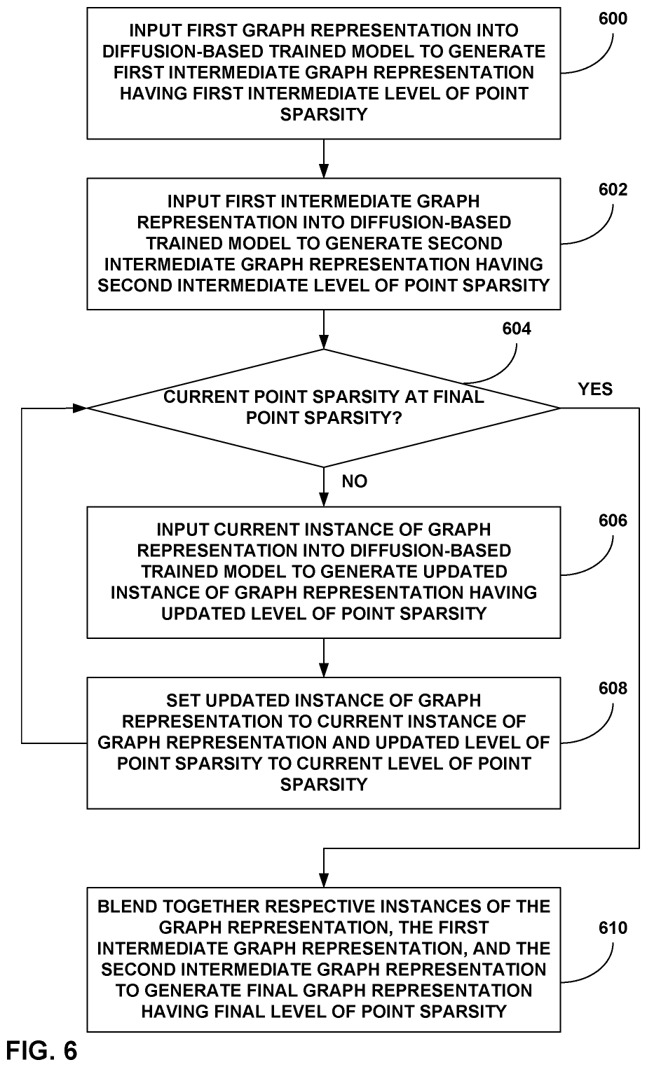

FIG. 6 is flowchart illustrating an example method of upsampling using a diffusion-based model in accordance with one or more examples described in this disclosure. One or more processors 110 may input a first graph representation into diffusion-based trained model 194 to generate a first intermediate graph representation having a first intermediate level of point sparsity (600). One or more processors 110 may input the first intermediate graph representation having the first intermediate level of point sparsity into diffusion-based trained model 194 to generate second intermediate graph representation having second intermediate level of point sparsity (602).

One or more processors 110 may determine whether the current point sparsity is at the final point sparsity (e.g., point sparsity for 128-channel LiDAR) (604). If the current sparsity is not at the final point sparsity (NO of 604), one or more processors 110 may input the current instance of the graph representation into diffusion-based trained model 194 to generate updated instance of graph representation having updated level of point sparsity (e.g., less point sparsity or more point density) (606).

One or more processors 110 may set the updated instance of the graph representation to the current instance of the graph representation and updated level of point sparsity to current level of point sparsity (608). One or more processors 110 may repeat the operations of determining whether the current point sparsity is at the final point sparsity, and inputting the current instance of graph representation into diffusion-based trained model 194 to generate updated instance of graph representation having updated level of point sparsity until the current point sparsity is at the final point sparsity.

If the current point sparsity is at the final point sparsity (YES of 604), one or more processors 110 may blend together respective instances of the graph representation, the first intermediate graph representation, and the second intermediate graph representation to generate the second graph representation (610). However, in some examples, such blending is not necessarily. Instead, one or more processors 110 may set the second graph representation equal to the instance of the intermediate graph representation having a point sparsity that is equal to the desired point sparsity (e.g., point sparsity for 128-channel LiDAR sensor).

The following numbered clauses illustrate one or more aspects of the devices and techniques described in this disclosure.

Clause 1. A method of processing image content, the method comprising: receiving first point cloud data having a first level of point sparsity; constructing a first graph representation having the first level of point sparsity from the first point cloud data; performing diffusion-based upsampling on the first graph representation having the first level of point sparsity to generate a second graph representation having a second level of point sparsity, wherein performing diffusion-based upsampling comprises: inputting the first graph representation into a diffusion-based trained model to generate a first intermediate graph representation having a first intermediate level of point sparsity, the first intermediate level of point sparsity being denser than the first level of point sparsity; inputting the first intermediate graph representation into the diffusion-based trained model to generate a second intermediate graph representation having a second intermediate level of point sparsity, the second intermediate level of point sparsity being denser than the first intermediate level of point sparsity; and generating the second graph representation having the second level of point sparsity based on at least on the second intermediate graph representation; and generating second point cloud data having the second level of point sparsity based on the second graph representation having the second level of point sparsity.

Clause 2. The method of clause 1, wherein the second intermediate graph representation having the second intermediate level of point sparsity comprises a current instance of graph representation having a current level of point sparsity, the method further comprising: iteratively updating the current instance of the graph representation to generate an updated instance of the graph representation having an updated level of point sparsity based on iteratively inputting the current instance of graph representation into the diffusion-based trained model until the updated level of point sparsity is equal to the second level of point sparsity, wherein generating the second graph representation comprises blending together respective instances of the graph representation, the first intermediate graph representation, and the second intermediate graph representation to generate the second graph representation.

Clause 3. The method of any of clauses 1 and 2, wherein generating the second point cloud data having the second level of point sparsity based on the second graph representation having the second level of point sparsity comprises: deconstructing the second graph representation into the second point cloud data having the second level of point sparsity.

Clause 4. The method of any of clauses 1-3, wherein constructing a first graph representation having the first level of point sparsity from the first point cloud data comprises: converting the first point cloud data into a plurality of discrete voxels; determining a respective spatial neighborhood for each voxel of the plurality of discrete voxels; determining adjacency of voxels in each respective spatial neighborhood; and determining an adjacency matrix based on the adjacency of voxels and edge weight of each of the voxels, wherein the first graph representation is the adjacency matrix.

Clause 5. The method of any of clauses 1-4, wherein the diffusion-based trained model is configured to propagate information from neighboring points in the first point cloud data to a point in the first point cloud data to generate additional points.

Clause 6. The method of clause 5, wherein the information includes average intensity of neighboring points and an intensity of the point.

Clause 7. The method of any of clauses 1-6, wherein the first point cloud data having the first level of point sparsity comprises the first point cloud data from a LiDAR system that includes one of 32 or 64 beams.

Clause 8. The method of any of clauses 1-7, wherein the second point cloud data having the second level of point sparsity comprises second point cloud data indicative of a prediction of point cloud data generated from a LiDAR system that includes 128 beams.

Clause 9. The method of any of clauses 1-8, further comprising: controlling operation of a vehicle based on the second point cloud data.

Clause 10. The method of any of clauses 1-9, further comprising: receiving, from one or more servers, the diffusion-based trained model that has been trained based on a plurality of sets of training point cloud data, wherein each set of training point cloud data is one threshold amount sparser than another set of training point cloud data.

Clause 11. An apparatus for processing image content, the apparatus comprising: one or more memories; and one or more processors coupled to the one or more memories and implemented in circuitry, wherein the one or more processors are configured to: receive first point cloud data having a first level of point sparsity; construct a first graph representation having the first level of point sparsity from the first point cloud data; perform diffusion-based upsampling on the first graph representation having the first level of point sparsity to generate a second graph representation having a second level of point sparsity, wherein to perform diffusion-based upsampling, the one or more processors are configured to: input the first graph representation into a diffusion-based trained model to generate a first intermediate graph representation having a first intermediate level of point sparsity, the first intermediate level of point sparsity being denser than the first level of point sparsity; input the first intermediate graph representation into the diffusion-based trained model to generate a second intermediate graph representation having a second intermediate level of point sparsity, the second intermediate level of point sparsity being denser than the first intermediate level of point sparsity; and generate the second graph representation having the second level of point sparsity based on at least on the second intermediate graph representation; and generate second point cloud data having the second level of point sparsity based on the second graph representation having the second level of point sparsity.

Clause 12. The apparatus of clause 11, wherein the second intermediate graph representation having the second intermediate level of point sparsity comprises a current instance of graph representation having a current level of point sparsity, wherein the one or more processors are configured to: iteratively update the current instance of the graph representation to generate an updated instance of the graph representation having an updated level of point sparsity based on iteratively inputting the current instance of graph representation into the diffusion-based trained model until the updated level of point sparsity is equal to the second level of point sparsity, wherein to generate the second graph representation, the one or more processors are configured to blend together respective instances of the graph representation, the first intermediate graph representation, and the second intermediate graph representation to generate the second graph representation.

Clause 13. The apparatus of any of clauses 11 and 12, wherein to generate the second point cloud data having the second level of point sparsity based on the second graph representation having the second level of point sparsity, the one or more processors are configured to: deconstruct the second graph representation into the second point cloud data having the second level of point sparsity.

Clause 14. The apparatus of any of clauses 11-13, wherein to construct a first graph representation having the first level of point sparsity from the first point cloud data, the one or more processors are configured to: convert the first point cloud data into a plurality of discrete voxels; determine a respective spatial neighborhood for each voxel of the plurality of discrete voxels; determining adjacency of voxels in each respective spatial neighborhood; and determine an adjacency matrix based on the adjacency of voxels and edge weight of each of the voxels, wherein the first graph representation is the adjacency matrix.

Clause 15. The apparatus of any of clauses 11-14, wherein the diffusion-based trained model is configured to propagate information from neighboring points in the first point cloud data to a point in the first point cloud data to generate additional points.

Clause 16. The apparatus of clause 15, wherein the information includes average intensity of neighboring points and an intensity of the point.

Clause 17. The apparatus of any of clauses 11-16, wherein the first point cloud data having the first level of point sparsity comprises the first point cloud data from a LiDAR system that includes one of 32 or 64 beams.

Clause 18. The apparatus of any of clauses 11-17, wherein the second point cloud data having the second level of point sparsity comprises second point cloud data indicative of a prediction of point cloud data generated from a LiDAR system that includes 128 beams.

Clause 19. The apparatus of any of clauses 11-18, wherein the one or more processors are configured to: control operation of a vehicle based on the second point cloud data.

Clause 20. The apparatus of any of clauses 11-19, wherein the one or more processors are configured to: receive, from one or more servers, the diffusion-based trained model that has been trained based on a plurality of sets of training point cloud data, wherein each set of training point cloud data is one threshold amount sparser than another set of training point cloud data.

Clause 21. A computer-readable storage medium storing instructions thereon that when executed cause one or more processors to: receive first point cloud data having a first level of point sparsity; construct a first graph representation having the first level of point sparsity from the first point cloud data; perform diffusion-based upsampling on the first graph representation having the first level of point sparsity to generate a second graph representation having a second level of point sparsity, wherein the instructions that cause the one or more processors to perform diffusion-based upsampling comprise instructions that cause the one or more processors to: input the first graph representation into a diffusion-based trained model to generate a first intermediate graph representation having a first intermediate level of point sparsity, the first intermediate level of point sparsity being denser than the first level of point sparsity; input the first intermediate graph representation into the diffusion-based trained model to generate a second intermediate graph representation having a second intermediate level of point sparsity, the second intermediate level of point sparsity being denser than the first intermediate level of point sparsity; and generate the second graph representation having the second level of point sparsity based on at least on the second intermediate graph representation; and generate second point cloud data having the second level of point sparsity based on the second graph representation having the second level of point sparsity.

Clause 22. The computer-readable storage medium of clause 21, further comprising instructions that cause the one or more processors to perform the method of any of clauses 2-10.

Clause 23. An apparatus comprising means for performing the method of any of clauses 1-10.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable gate arrays (FPGAs), or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of processing image content, the method comprising:
receiving first point cloud data having a first level of point sparsity;
constructing a first graph representation having the first level of point sparsity from the first point cloud data;
performing diffusion-based upsampling on the first graph representation having the first level of point sparsity to generate a second graph representation having a second level of point sparsity, wherein performing diffusion-based upsampling comprises:
inputting the first graph representation into a diffusion-based trained model to generate a first intermediate graph representation having a first intermediate level of point sparsity, the first intermediate level of point sparsity being denser than the first level of point sparsity;
inputting the first intermediate graph representation into the diffusion-based trained model to generate a second intermediate graph representation having a second intermediate level of point sparsity, the second intermediate level of point sparsity being denser than the first intermediate level of point sparsity; and
generating the second graph representation having the second level of point sparsity based on at least on the second intermediate graph representation; and
generating second point cloud data having the second level of point sparsity based on the second graph representation having the second level of point sparsity.

2. The method of claim 1, wherein the second intermediate graph representation having the second intermediate level of point sparsity comprises a current instance of graph representation having a current level of point sparsity, the method further comprising:
iteratively updating the current instance of the graph representation to generate an updated instance of the graph representation having an updated level of point sparsity based on iteratively inputting the current instance of graph representation into the diffusion-based trained model until the updated level of point sparsity is equal to the second level of point sparsity,
wherein generating the second graph representation comprises blending together respective instances of the graph representation, the first intermediate graph representation, and the second intermediate graph representation to generate the second graph representation.

3. The method of claim 1, wherein generating the second point cloud data having the second level of point sparsity based on the second graph representation having the second level of point sparsity comprises:
deconstructing the second graph representation into the second point cloud data having the second level of point sparsity.

4. The method of claim 1, wherein constructing a first graph representation having the first level of point sparsity from the first point cloud data comprises:
converting the first point cloud data into a plurality of discrete voxels;
determining a respective spatial neighborhood for each voxel of the plurality of discrete voxels;
determining adjacency of voxels in each respective spatial neighborhood; and
determining an adjacency matrix based on the adjacency of voxels and edge weight of each of the voxels,
wherein the first graph representation is the adjacency matrix.

5. The method of claim 1, wherein the diffusion-based trained model is configured to propagate information from neighboring points in the first point cloud data to a point in the first point cloud data to generate additional points.

6. The method of claim 5, wherein the information includes average intensity of neighboring points and an intensity of the point.

7. The method of claim 1, wherein the first point cloud data having the first level of point sparsity comprises the first point cloud data from a LiDAR system that includes one of 32 or 64 beams.

8. The method of claim 1, wherein the second point cloud data having the second level of point sparsity comprises second point cloud data indicative of a prediction of point cloud data generated from a LiDAR system that includes 128 beams.

9. The method of claim 1, further comprising:
controlling operation of a vehicle based on the second point cloud data.

10. The method of claim 1, further comprising:
receiving, from one or more servers, the diffusion-based trained model that has been trained based on a plurality of sets of training point cloud data, wherein each set of training point cloud data is one threshold amount sparser than another set of training point cloud data.

11. An apparatus for processing image content, the apparatus comprising:
one or more memories; and
one or more processors coupled to the one or more memories and implemented in circuitry, wherein the one or more processors are configured to:
receive first point cloud data having a first level of point sparsity;
construct a first graph representation having the first level of point sparsity from the first point cloud data;
perform diffusion-based upsampling on the first graph representation having the first level of point sparsity to generate a second graph representation having a second level of point sparsity, wherein to perform diffusion-based upsampling, the one or more processors are configured to:
input the first graph representation into a diffusion-based trained model to generate a first intermediate graph representation having a first intermediate level of point sparsity, the first intermediate level of point sparsity being denser than the first level of point sparsity;
input the first intermediate graph representation into the diffusion-based trained model to generate a second intermediate graph representation having a second intermediate level of point sparsity, the second intermediate level of point sparsity being denser than the first intermediate level of point sparsity; and
generate the second graph representation having the second level of point sparsity based on at least on the second intermediate graph representation; and
generate second point cloud data having the second level of point sparsity based on the second graph representation having the second level of point sparsity.

12. The apparatus of claim 11, wherein the second intermediate graph representation having the second intermediate level of point sparsity comprises a current instance of graph representation having a current level of point sparsity, wherein the one or more processors are configured to:
iteratively update the current instance of the graph representation to generate an updated instance of the graph representation having an updated level of point sparsity based on iteratively inputting the current instance of graph representation into the diffusion-based trained model until the updated level of point sparsity is equal to the second level of point sparsity,
wherein to generate the second graph representation, the one or more processors are configured to blend together respective instances of the graph representation, the first intermediate graph representation, and the second intermediate graph representation to generate the second graph representation.

13. The apparatus of claim 11, wherein to generate the second point cloud data having the second level of point sparsity based on the second graph representation having the second level of point sparsity, the one or more processors are configured to:
deconstruct the second graph representation into the second point cloud data having the second level of point sparsity.

14. The apparatus of claim 11, wherein to construct a first graph representation having the first level of point sparsity from the first point cloud data, the one or more processors are configured to:
convert the first point cloud data into a plurality of discrete voxels;
determine a respective spatial neighborhood for each voxel of the plurality of discrete voxels;
determining adjacency of voxels in each respective spatial neighborhood; and
determine an adjacency matrix based on the adjacency of voxels and edge weight of each of the voxels,
wherein the first graph representation is the adjacency matrix.

15. The apparatus of claim 11, wherein the diffusion-based trained model is configured to propagate information from neighboring points in the first point cloud data to a point in the first point cloud data to generate additional points.

16. The apparatus of claim 15, wherein the information includes average intensity of neighboring points and an intensity of the point.

17. The apparatus of claim 11, wherein the first point cloud data having the first level of point sparsity comprises the first point cloud data from a LiDAR system that includes one of 32 or 64 beams.

18. The apparatus of claim 11, wherein the second point cloud data having the second level of point sparsity comprises second point cloud data indicative of a prediction of point cloud data generated from a LiDAR system that includes 128 beams.

19. The apparatus of claim 11, wherein the one or more processors are configured to:
control operation of a vehicle based on the second point cloud data.

20. The apparatus of claim 11, wherein the one or more processors are configured to:
receive, from one or more servers, the diffusion-based trained model that has been trained based on a plurality of sets of training point cloud data, wherein each set of training point cloud data is one threshold amount sparser than another set of training point cloud data.

21. A computer-readable storage medium storing instructions thereon that when executed cause one or more processors to:
receive first point cloud data having a first level of point sparsity;
construct a first graph representation having the first level of point sparsity from the first point cloud data;
perform diffusion-based upsampling on the first graph representation having the first level of point sparsity to generate a second graph representation having a second level of point sparsity, wherein the instructions that cause the one or more processors to perform diffusion-based upsampling comprise instructions that cause the one or more processors to:
input the first graph representation into a diffusion-based trained model to generate a first intermediate graph representation having a first intermediate level of point sparsity, the first intermediate level of point sparsity being denser than the first level of point sparsity;
input the first intermediate graph representation into the diffusion-based trained model to generate a second intermediate graph representation having a second intermediate level of point sparsity, the second intermediate level of point sparsity being denser than the first intermediate level of point sparsity; and
generate the second graph representation having the second level of point sparsity based on at least on the second intermediate graph representation; and
generate second point cloud data having the second level of point sparsity based on the second graph representation having the second level of point sparsity.
